(19) United States
(12) Patent Application Publication
(10) Pub. No.: US 2016/0224591 A1
(43) Pub. Date: Aug. 4, 2016

(54) Method and Device for Searching for Image

(71) Applicant: Samsung Electronics Co., Ltd., Suwon-si (KR)

(72) Inventors: Hye-sun KIM, Yongin-si (KR); Su-jung BAE, Yongin-si (KR); Seong-oh LEE, Yongin-si (KR); Moon-sik JEONG, Seongnam-si (KR); Hyeon-hee CHA, Suwon-si (KR); Sung-do CHOI, Suwon-si (KR); Hyun-soo CHOI, Seoul (KR)

(21) Appl. No.: 15/013,012

(22) Filed: Feb. 2, 2016

(30) Foreign Application Priority Data
Feb. 3, 2015 (KR) 10-2015-0016732

(51) Int. Cl. G06F 17/30; G06T 7/00; G06F 3/0488; G06K 9/62; G06K 9/46; G06F 3/0484; G06K 9/20; G06K 9/00

(52) U.S. Cl. CPC G06F 17/30247; G06K 9/2081; G06T 7/0085; G06K 9/00375; G06K 9/6202; G06K 9/46; G06K 9/4652; G06K 9/00288; G06F 3/04842; G06F 3/04883

(57) ABSTRACT

A method for searching for an image includes receiving a user input to select a region of interest from an image; displaying an indicator showing the region of interest; determining at least one piece of identification information for the region of interest as a search word; searching for an image corresponding to the search word from an image database; and displaying a found image.

### RELATED APPLICATION(S)

This application claims the benefit of Korean Patent Application No. 10-2015-0016732, filed on Feb. 3, 2015, in the Korean Intellectual Property Office, the disclosure of which is incorporated herein in its entirety by reference.

### BACKGROUND

The present disclosure relates to images on an electronic device, and more particularly, to methods and devices for searching for an image.

As time goes on, ever more electronic devices are introduced to the public. Many of these electronic devices allow users to take videos and still pictures (collectively called images), as well as download images and also copy images to the electronic devices. With memories associated with these electronic devices easily going to multi-gigabytes, and multi-terabytes for many desktop personal computers (PCs), the sheer number of images that may need to be searched by a user when looking for a specific still picture or video can be overwhelming.

A user can come across many types of images, but the images that the user prefers may be different from these images. Moreover, a user may be interested in a specific portion of an image.

### SUMMARY

Provided are methods and devices for searching for an image in an image database. Various aspects will be set forth in part in the description that follows, and these aspects will be apparent from the description and/or may be learned by practice of the presented exemplary embodiments.

According to an aspect of an exemplary embodiment, a method of searching for an image includes receiving a first user input to select a region of interest in a displayed image and displaying an indicator to show the region of interest. Then a search word may be determined, wherein the search word comprises at least one piece of identification information for the region of interest. The search word may be used to search at least one target image in an image database. When the search word matches appropriately an identification information of any of the target images, the target image is referred to as a found image, and the found image is displayed.

The indicator may be displayed by at least one of highlighting a boundary line of the region of interest, changing a size of the region of interest, and changing depth information of the region of interest.

The first user input is a user touch on an area of the displayed image.

A size of the region of interest may be changed according to a duration of the user touch.

The size of the region of interest may increase according to an increase of the duration.

The region of interest may be at least one of an object, a background, and text included in the image.

The method may further include displaying the identification information for the region of interest.

The search word may be determined by a second user input to select at least one piece of the displayed identification information.

When the search word is a positive search word, the found image is any of the at least one target image having the search word as a piece of the identification information.

When the search word is a negative search word, the found image is any of the at least one target image that does not have the search word as a piece of the identification information.

The found image may be acquired based on at least one of attribute information of the region of interest and image analysis information of the image.

The image may include a first image and a second image, where the region of interest comprises a first partial image of the first image and a second partial image of the second image.

The method may further include: receiving text and determining the text as the search word.

The image database may be stored in at least one of a web server, a cloud server, a social networking service (SNS) server, and a portable device.

The displayed image may be at least one of a live view image, a still image, and a moving image frame.

The found image may be a moving image frame, and when there is a plurality of the found image, displaying the found image comprises sequentially displaying the moving image frame.

According to an aspect of another exemplary embodiment, a device includes a display unit configured to display a displayed image, a user input unit configured to receive a user input to select a region of interest, and a control unit configured to control the display unit to display an indicator about the region of interest.

The device may further include: a database configured to store images, wherein the control unit is further configured to determine at least one piece of identification information for the region of interest based on a result received from the user input unit and to search for a target image with an identification information corresponding to the search word.

The identification information may be a posture of a person included in the region of interest.

When the search word is a positive search word, the found image may be the target image with the identification information corresponding to the search word, and when the search word is a negative search word, the found image may be the target image with the identification information that does not correspond to the search word.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1A to 1E are block diagrams of a device according to an exemplary embodiment.

FIG. 1F is a flowchart of a method of searching for an image, according to an exemplary embodiment;

FIG. 2 is a reference view for explaining a method of providing an indicator to an object, according to an exemplary embodiment;

FIG. 3 is a reference view for explaining a method of providing an indicator to an object by resizing the object, according to an exemplary embodiment;

FIG. 4 is a reference view for explaining a method of providing an indicator to an object by changing depth information of a region of interest, according to an exemplary embodiment;

FIG. 5 is a reference view for explaining a method of selecting a plurality of objects on a single image as a region of interest, according to an exemplary embodiment;

FIG. 6 is a reference view for explaining a method of selecting a plurality of objects on a single image as a region of interest, according to another exemplary embodiment;

FIG. 7 is a reference view for explaining a method of selecting a background as a region of interest, according to an exemplary embodiment;

FIG. 8 is a reference view for explaining a method of selecting a region of interest using a plurality of images, according to an exemplary embodiment;

FIG. 9 is a flowchart of a method used by a device to determine a search word from identification information, according to an exemplary embodiment;

FIG. 10 is a flowchart of a method used by a device to generate identification information, according to an exemplary embodiment;

FIG. 11 illustrates attribute information of an image according to an exemplary embodiment;

FIG. 12 is a reference view for explaining an example in which a device generates identification information of an image based on attribute information of an image;

FIG. 13 is a reference view for explaining an example in which a device generates identification information by using image analysis information;

FIG. 14 illustrates an example in which a device displays an identification information list, according to an exemplary embodiment;

FIG. 15 is a reference view for explaining a method of determining a search word from identification information according to an exemplary embodiment;

FIG. 16 is a reference view for explaining a method of determining a search word from a plurality of images according to an exemplary embodiment;

FIG. 17 is a reference view for explaining a method used by a device to include text such as a search word according to an exemplary embodiment;

FIGS. 18A through 18D are reference views for explaining a method of providing a search result according to an exemplary embodiment; and

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

Although general terms widely used at present were selected for describing the present disclosure in consideration of the functions thereof, these general terms may vary according to intentions of one of ordinary skill in the art, case precedents, the advent of new technologies, and the like. Some specific terms with specific meanings are also used in the present disclosure. When the meaning of a term is in doubt, the definition should first be sought in the present disclosure, including the claims and drawings, based on stated definitions, or usage in context if there is no definition. After that, the definition for a term should be what a person of ordinary skill in the arts would understand in the context of this disclosure.

The terms “comprises,” “comprising,” “includes,” and/or “including” specify the presence of the stated elements, but do not preclude the presence of other elements whether they are the same type as the stated elements or not. The terms “unit” and “module” when used in this disclosure refers to a unit that performs at least one function or operation, and may be implemented as hardware, software, or a combination of hardware and software. Software may comprise any executable code, whether compiled or interpretable, for example, that can be executed to perform a desired operation.

Throughout this disclosure, an “image” may include an object and a background. The object is a partial image that may be distinguished from the background with a contour line via image processing or the like. The object may be a portion of the image such as, for example, a human being, an animal, a building, a vehicle, or the like. The image minus the object can be considered to be the background.

Accordingly, an object or a background may be partial images, and they may not be fixed but relative. For example, in an image that has a human being, a vehicle, and the sky, the human and the vehicle may be objects, and the sky may be a background. In an image including a human being and a vehicle, the human being may be an object, and the vehicle may be a background. A face of the human being and the entire body of the human being may be objects. However, the size of a partial image for an object is generally smaller than that of a partial image for a background, although there may be exceptions to this. Each device may use its own previously defined criteria for distinguishing an object from a background.

Throughout the disclosure, an image may be a still image (for example, a picture or a drawing), a moving image (for example, a TV program image, a Video On Demand (VOD), a user-created content (UCC), a music video, or a YouTube image), a live view image, a menu image, or the like. A region of interest in an image may be a partial image such as an object or a background of the image.

An image system capable of searching for an image will now be described. The image system may include a device capable of reproducing and storing an image, and may further include an external device (for example, a server) that stores the image. When the image system includes the external device, the device and the external device may interact to search for one or more images.

The device according to an exemplary embodiment may be one of various types presently available, but may also include devices that will be developed in the future. The devices presently available may be, for example, a desktop computer, a mobile phone, a smartphone, a laptop computer, a tablet personal computer (PC), an e-book terminal, a digital broadcasting terminal, a personal digital assistant (PDA), a portable multimedia player (PMP), a navigation, an MP3 player, a digital camera, a camcorder, an Internet Protocol television (IPTV), a digital television (DTV), a consumer electronics (CE) apparatus (e.g., a refrigerator and an air-conditioner each including a display), or the like, but embodiments are not limited thereto. The device may also be a device that is wearable by users. For example, the device may be a watch, eyeglasses, a ring, a bracelet, a necklace, or the like.

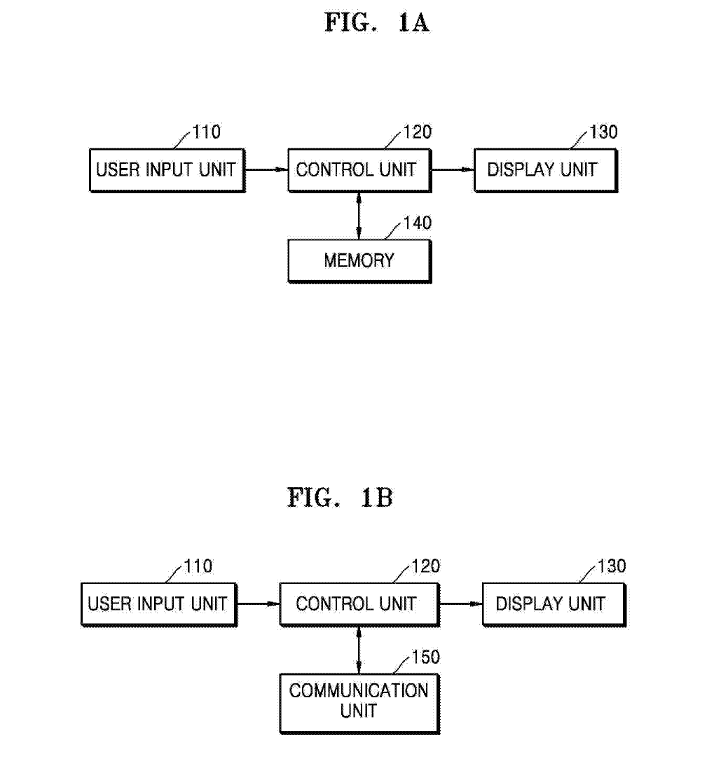

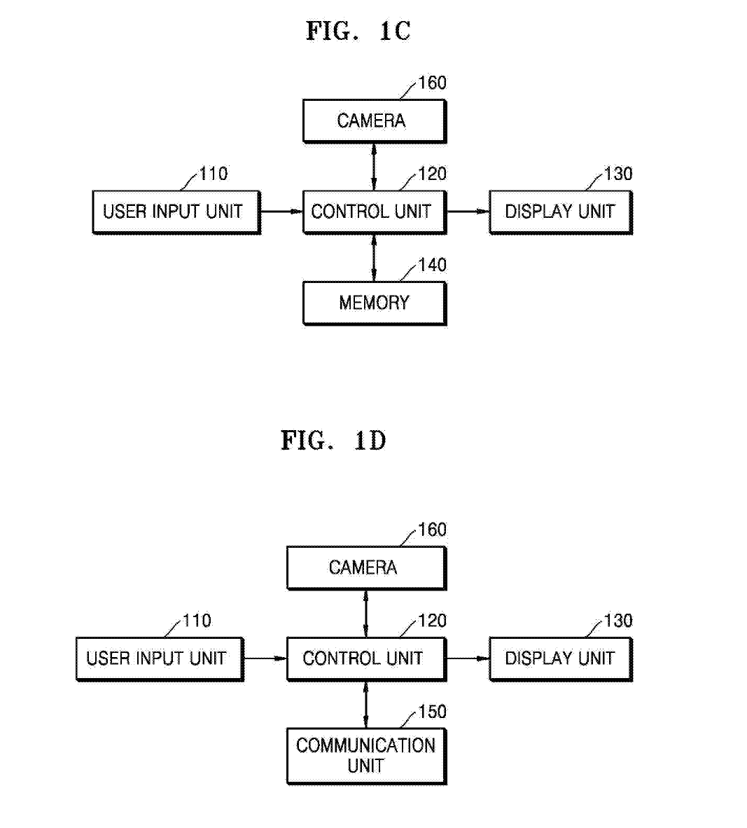

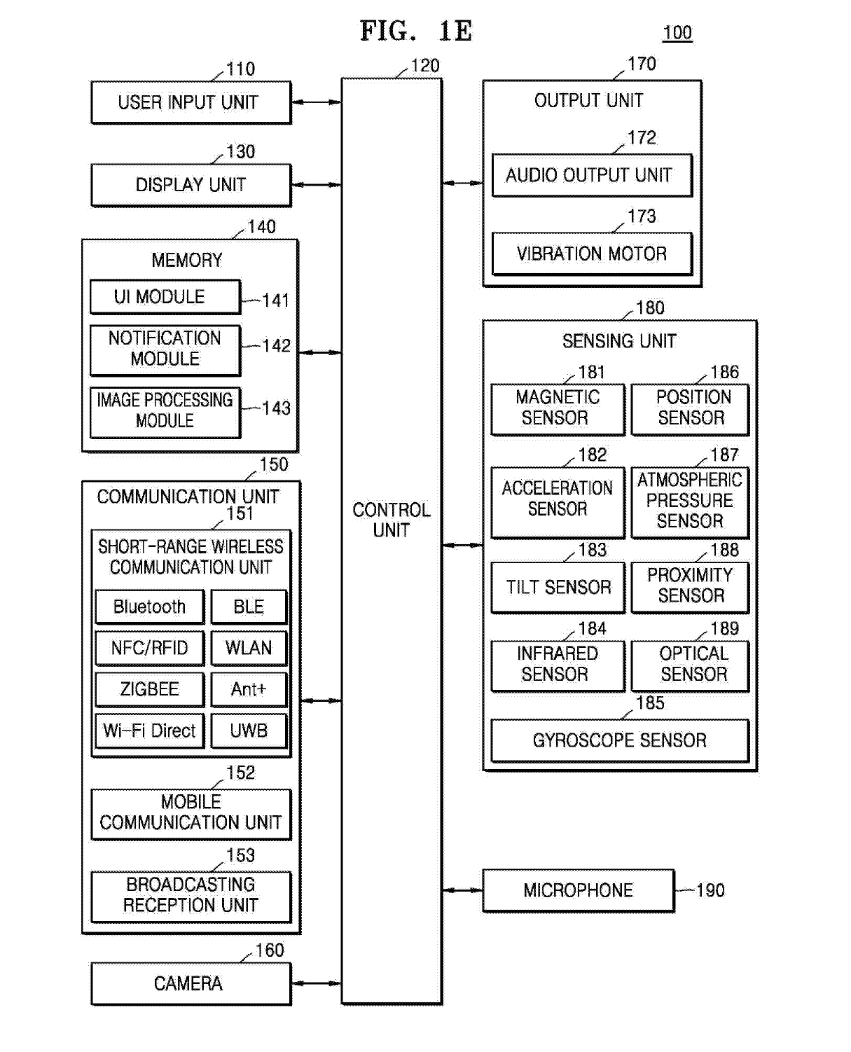

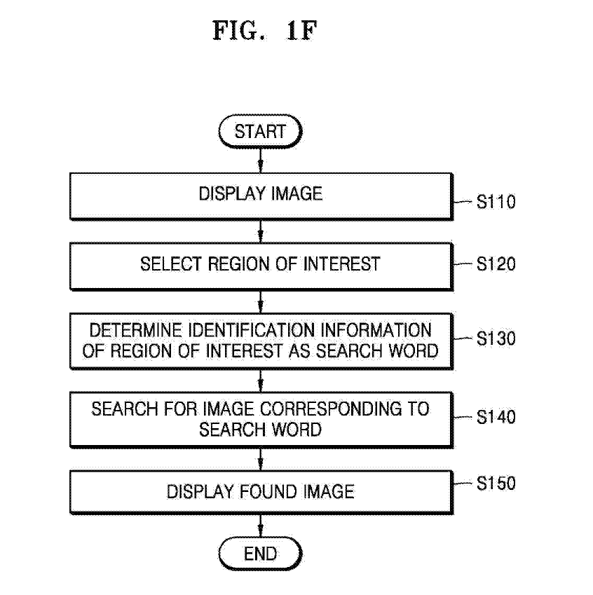

FIGS. 1A to 1E are block diagrams of a device 100 according to various embodiments.

As shown in FIG. 1A, the device 100 according to an exemplary embodiment may include a user input unit 110, a control unit 120, a display unit 130, and a memory 140. The device 100 may provide an effect to a still image or a moving image that is stored in the memory 140. The device 100 may search for images stored in the memory 140 using a region of interest of an image displayed on the display unit 130.

Alternatively, as shown in FIG. 1B, the device 100 according to an exemplary embodiment may include the user input unit 110, the control unit 120, the display unit 130, and a communication unit 150. The device 100 may search for images stored in an external device using a region of interest of an image displayed on the display unit 130. The image displayed on the display unit 130 may be also received from the external device.

Alternatively, as shown in FIGS. 1C and 1D, the device 100 according to an exemplary embodiment may further include a camera 160. The device 100 may select a region of interest using a live view image captured by the camera 160. All of the illustrated components are not essential. The device 100 may include more or less components than those illustrated in FIGS. 1A through 1D.

As illustrated in FIG. 1E, the device 100 according to an exemplary embodiment may further include an output unit 170, a sensing unit 180, and a microphone 190, in addition to the components of each of the devices 100 of FIGS. 1A through 1D. The aforementioned components will now be described in detail.

The user input unit 110 denotes a unit via which a user inputs data for controlling the device 100. For example, the user input unit 110 may be, but not limited to, a key pad, a dome switch, a touch pad (e.g., a capacitive overlay type, a resistive overlay type, an infrared beam type, an integral strain gauge type, a surface acoustic wave type, a piezo electric type, or the like), a jog wheel, or a jog switch.

The user input unit 110 may receive a user input of selecting a region of interest on an image. According to an exemplary embodiment of the present disclosure, the user input of selecting a region of interest may vary. For example, the user input may be a key input, a touch input, a motion input, a bending input, a voice input, or multiple inputs.

According to an exemplary embodiment of the present disclosure, the user input unit 110 may receive an input of selecting a region of interest from an image.

The user input unit 110 may receive an input of selecting at least one piece of identification information from an identification information list.

The control unit 120 may typically control all operations of the device 100. For example, the control unit 120 may control the user input unit 110, the output unit 170, the communication unit 150, the sensing unit 180, and the microphone 190 by executing programs stored in the memory 140.

The control unit 120 may acquire at least one piece of identification information that identifies the selected region of interest. For example, the control unit 120 may generate identification information by checking attribute information of the selected region of interest and generalizing the attribute information. The control unit 120 may detect identification information by using image analysis information about the selected region of interest. The control unit 120 may acquire identification information of the second image in addition to the identification information of the region of interest.

The control unit 120 may display an indicator to show the region of interest. The indicator may include highlighting a boundary line of the region of interest, changing a size of the region of interest, changing depth information of the region of interest, etc.

The display unit 130 may display information processed by the device 100. For example, the display unit 130 may display a still image, a moving image, or a live view image. The display unit 130 may also display identification information that identifies the region of interest. The display unit 130 may also display images found via the search process.

When the display unit 130 forms a layer structure together with a touch pad to construct a touch screen, the display unit 130 may be used as an input device as well as an output device. The display unit 130 may include at least one selected from a liquid crystal display (LCD), a thin film transistor-liquid crystal display (TFT-LCD), an organic light-emitting diode (OLED), a flexible display, a 3D display, and an electrophoretic display. According to some embodiments of the present disclosure, the device 100 may include two or more of the display units 130.

The memory 140 may store a program that can be executed by the control unit 120 to perform processing and control, and may also store input/output data (for example, a plurality of images, a plurality of folders, and a preferred folder list).

The memory 140 may include at least one type of storage medium from among, for example, a flash memory type, a hard disk type, a multimedia card type, a card type memory (for example, a secure digital (SD) or extreme digital (XD) memory), random access memory (RAM), a static random access memory (SRAM), read-only memory (ROM), electrically erasable programmable ROM (EEPROM), programmable ROM (PROM), magnetic memory, a magnetic disk, and an optical disk. The device 100 may operate a web storage on the internet which performs a storage function of the memory 140.

The programs stored in the memory 140 may be classified into a plurality of modules according to their functions, for example, a user interface (UI) module 141, a notification module 142, and an image processing module 143.

The UI module 141 may provide a UI, graphical UI (GUI), or the like that is specialized for each application and interoperates with the device 100. The notification module 142 may generate a signal for notifying that an event has been generated in the device 100. The notification module 142 may output a notification signal in the form of a video signal via the display unit 130, in the form of an audio signal via an audio output unit 172, or in the form of a vibration signal via a vibration motor 173.

The image processing module 143 may acquire object information, edge information, atmosphere information, color information, and the like included in a captured image by analyzing the captured image.

According to an exemplary embodiment of the present disclosure, the image processing module 143 may detect a contour line of an object included in the captured image. According to an exemplary embodiment of the present disclosure, the image processing module 143 may acquire the type, name, and the like of the object by comparing the contour line of the object included in the image with a predefined template. For example, when the contour line of the object is similar to a template of a vehicle, the image processing module 143 may recognize the object included in the image as a vehicle.

According to an exemplary embodiment of the present disclosure, the image processing module 143 may perform face recognition on the object included in the image. For example, the image processing module 143 may detect a face region of a human from the image. Examples of a face region detecting method may include knowledge-based methods, feature-based methods, template-matching methods, and appearance-based methods, but embodiments are not limited thereto.

The image processing module 143 may also extract facial features (for example, the shapes of the eyes, the nose, and the mouth as major parts of a face) from the detected face region. To extract a facial feature from a face region, a Gabor filter, local binary pattern (LBP), or the like may be used, but embodiments are not limited thereto.

The image processing module 143 may compare the facial feature extracted from the face region within the image with facial features of pre-registered users. For example, when the extracted facial feature is similar to a facial feature of a pre-registered first register (e.g., Tom), the image processing module 143 may determine that an image of the first user is included in the image.

According to an exemplary embodiment of the present disclosure, the image processing module 143 may compare a certain area of an image with a color map (color histogram) and extract visual features, such as a color arrangement, a pattern, and an atmosphere of the image, as image analysis information.

The communication unit 150 may include at least one component that enables the device 100 to perform data communication with a cloud server, an external device, a social networking service (SNS) server, or an external wearable device. For example, the communication unit 150 may include a short-range wireless communication unit 151, a mobile communication unit 152, and a broadcasting reception unit 153.

The short-range wireless communication unit 151 may include, but is not limited to, a Bluetooth communication unit, a Bluetooth Low Energy (BLE) communicator, a near field communication (NFC) unit, a wireless local area network (WLAN) (e.g., Wi-Fi) communication unit, a ZigBee communication unit, an infrared Data Association (IrDA) communication unit, a Wi-Fi direct (WFD) communication unit, an ultra wideband (UWB) communication unit, an Ant+ communication unit, and the like.

The mobile communication unit 152 may exchange a wireless signal with at least one of a base station, an external terminal, and a server on a mobile communication network. Examples of the wireless signal may include a voice call signal, a video call signal, and various types of data generated during a short message service (SMS)/multimedia messaging service (MMS).

The broadcasting reception unit 153 receives broadcast signals and/or broadcast-related information from an external source via a broadcast channel. The broadcast channel may be a satellite channel, a ground wave channel, or the like.

The communication unit 150 may share at least one of the first and second images, an effect image, an effect folder of effect images, and the identification information with the external device. The external device may be at least one of a cloud server, an SNS server, another device 100 of the same user, and a device 100 of another user, which are connected to the device 100, but embodiments are not limited thereto.

For example, the communication unit 150 may receive a still image or moving image stored in an external device or may receive from the external device a live view image captured by the external device. The communication unit 150 may transmit a command to search for an image corresponding to a search word and receive a transmission result.

The image frame obtained by the camera 160 may be stored in the memory 140 or transmitted to the outside via the communication unit 150. Some embodiments of the device 100 may comprise two or more of the cameras 160.

The output unit 170 outputs an audio signal, a video signal, or a vibration signal, and may include the audio output unit 172 and the vibration motor 173.

The audio output unit 172 may output audio data that is received from the communication unit 150 or stored in the memory 140. The audio output unit 172 may also output an audio signal (for example, a call signal receiving sound, a message receiving sound, a notification sound) related with a function of the device 100. The audio output unit 172 may include a speaker, a buzzer, and the like.

The vibration motor 173 may output a vibration signal. For example, the vibration motor 173 may output a vibration signal corresponding to an output of audio data or video data (for example, a call signal receiving sound or a message receiving sound). The vibration motor 173 may also output a vibration signal when a touch screen is touched.

The sensing unit 180 may sense the status of the device 100, the status of the surrounding of the device 100, or the status of a user who wears the device 100, and may transmit information corresponding to the sensed status to the control unit 120.

The sensing unit 180 may include, but is not limited to, at least one selected from a magnetic sensor 181, an acceleration sensor 182, a tilt sensor 183, an infrared sensor 184, a gyroscope sensor 185, a position sensor (e.g., a GPS) 186, an atmospheric pressure sensor 187, a proximity sensor 188, and an optical sensor 189. The sensing unit 180 may include, for example, a temperature sensor, an illumination sensor, a pressure sensor, and an iris recognition sensor. Functions of most of the sensors would be instinctively understood by one of ordinary skill in the art in view of their names and thus detailed descriptions thereof will be omitted herein.

The microphone 190 may be included as an audio/video (A/V) input unit. The microphone 190 receives an external audio signal and converts the external audio signal into electrical audio data. For example, the microphone 190 may receive an audio signal from an external device or a speaking person. The microphone 190 may use various noise removal algorithms in order to remove noise that is generated while receiving the external audio signal.

As described above, an effect may be provided to not only an image stored in the device 100 but also an image stored in an external device. The external device may be, for example, a social networking service (SNS) server, a cloud server, or a device 100 used by another user. Some embodiments of the device 100 may not include some of the elements described, such as, for example, the broadcast reception unit 153, while other embodiments may include another type of element.

FIG. 1F is a flowchart of a method of searching for an image, according to an exemplary embodiment.

In operation S110, a device 100 may display an image. The image may include an object and a background, and may be a still image, a moving image, a live view image, a menu image, or the like. According to an exemplary embodiment of the present disclosure, the image displayed on the device 100 may be a still image or a moving image that is stored in a memory embedded in the device 100, a live view image captured by a camera 160 embedded in the device 100, a still image or a moving image that is stored in an external device, for example, a portable terminal used by another user, a social networking service (SNS) server, a cloud server, or a web server, or may be a live view image captured by the external device.

In operation S120, the device 100 may select a region of interest. The region of interest is a partial image of the displayed image, and may be the object or the background. For example, the device 100 may select one object from among a plurality of objects as the region of interest, or may select at least two objects from among the plurality of objects as the region of interest. Alternatively, the device 100 may select the background of the image as the region of interest.

A user may also select the region of interest. For example, the device 100 may receive a user input of selecting a partial region on the image, and determine with further user input whether the selected region of interest should be an object or background.

According to an exemplary embodiment of the present disclosure, the user input for selecting the region of interest may vary. In the present specification, the user input may be a key input, a touch input, a motion input, a bending input, a voice input, multiple inputs, or the like.

“Touch input” denotes a gesture or the like that a user makes on a touch screen to control the device 100. Examples of the touch input may include tap, touch & hold, double tap, drag, panning, flick, and drag & drop.

“Tap” denotes an action of a user touching a screen with a fingertip or a touch tool (e.g., an electronic pen) and then very quickly lifting the fingertip or the touch tool from the screen without moving.

“Touch & hold” denotes a user maintaining a touch input for more than a critical time period (e.g., two seconds) after touching a screen with a fingertip or a touch tool (e.g., an electronic pen). For example, this action indicates a case in which a time difference between a touching-in time and a touching-out time is greater than the critical time period (e.g., two seconds). To allow the user to determine whether a touch input is a tap or a touch & hold, when the touch input is maintained for more than the critical time period, a feedback signal may be provided visually, audibly, or tactually. The critical time period may vary according to embodiments.

“Double tap” denotes an action of a user quickly touching a screen twice with a fingertip or a touch tool (e.g., an electronic pen).

“Drag” denotes an action of a user touching a screen with a fingertip or a touch tool and moving the fingertip or touch tool to other positions on the screen while touching the screen. When an object is moved using a drag action using this action, this may be referred to as “drag & drop.” When an object is not dragged, this action may be referred to as “panning.”

“Panning” denotes an action of a user performing a drag action without selecting any object. Since a panning action does not select a specific object, no object moves in a page. Instead, the whole page moves on a screen or a group of objects moves within a page.

“Flick” denotes an action of a user performing a drag action at a critical speed (e.g., 100 pixels/second) with a fingertip or a touch tool. A flick action may be differentiated from a drag (or panning) action, based on whether the speed of movement of the fingertip or the touch tool is greater than a critical speed (e.g. 100 pixels/second).

“Drag & drop” denotes an action of a user dragging and dropping an object to a predetermined location within a screen with a fingertip or a touch tool.

“Pinch” denotes an action of a user touching a screen with a plurality of fingertips or touch tools and widening or narrowing a distance between the plurality of fingertips or touch tools while touching the screen. “Unpinching” denotes an action of the user touching the screen with two fingers, such as a thumb and a forefinger and widening a distance between the two fingers while touching the screen, and “pinching” denotes an action of the user touching the screen with two fingers and narrowing a distance between the two fingers while touching the screen. A widening value or a narrowing value is determined according to a distance between the two fingers.

“Swipe” denotes an action of a user moving a fingertip or a touch tool a certain distance on a screen while touching an object on a screen with the fingertip or the touch tool.

“Motion input” denotes a motion that a user applies to the device 100 to control the device 100. For example, the motion input may be an input of a user rotating the device 100, tilting the device 100, or moving the device 100 horizontally or vertically. The device 100 may sense a motion input that is preset by a user, by using an acceleration sensor, a tilt sensor, a gyro sensor, a 3-axis magnetic sensor, or the like.

“Bending input” denotes an input of a user bending a portion of the device 100 or the whole device 100 to control the device 100 when the device 100 is a flexible display device. According to an exemplary embodiment of the present disclosure, the device 100 may sense, for example, a bending location (coordinate value), a bending direction, a bending angle, a bending speed, the number of times being bent, a point of time when bending occurs, and a period of time during which bending is maintained, by using a bending sensor.

“Key input” denotes an input of a user that controls the device 100 by using a physical key attached to the device 100 or a virtual keyboard displayed on a screen.

“Multiple inputs” denotes a combination of at least two input methods. For example, the device 100 may receive a touch input and a motion input from a user, or receive a touch input and a voice input from the user. Alternatively, the device 100 may receive a touch input and an eyeball input from the user. The eyeball input denotes an input of a user due to eye blinking, a staring at a location, an eyeball movement speed, or the like in order to control the device 100.

For convenience of explanation, a case where a user input is a key input or a touch input will now be described.

According to an exemplary embodiment, the device 100 may receive a user input of selecting a preset button. The preset button may be a physical button attached to the device 100 or a virtual button having a graphical user interface (GUI) form. For example, when a user selects both a first button (for example, a Home button) and a second button (for example, a volume control button), the device 100 may select a partial area on the screen.

The device 100 may receive a user input of touching a partial area of an image displayed on the screen. For example, the device 100 may receive an input of touching a partial area of a displayed image for a predetermined time period (for example, two seconds) or more or touching the partial area a predetermined number of times or more (for example, double tap). Then, the device 100 may determine an object or a background including the touched partial area as the region of interest.

The device 100 may determine the region of interest in the image, by using image analysis information. For example, the device 100 may detect a boundary line of various portions of the image using the image analysis information. The device 100 may determine a boundary line for an area including the touched area, and determine that as the region of interest.

Alternatively, the device 100 may extract the boundary line using visual features, such as a color arrangement or a pattern by comparing a certain area of the image with a color map (color histogram).

In operation S130, the device 100 may determine at least one piece of identification information of the region of interest as a search word. The device 100 may obtain the identification information of the region of interest before determining the search word. For example, a facial recognition software used by the device 100 may determine that the region of interest is a human face, and accordingly may associate the identification information of “face” with that region of interest. A method of obtaining the identification information will be described later.

The device 100 may display the obtained identification information and determine at least one piece of the identification information as the search word by a user input. The search word may include a positive search word and a negative search word. The positive search word may be a search word that needs to be included in a found image as the identification information. The negative search word may be a search word that does not need to be included in the found image as the identification information.

In operation S140, the device 100 may search for an image corresponding to the search word. A database (hereinafter referred to as an “image database”) that stores an image (hereinafter referred to as a “target image”) of a search target may be determined by a user input. For example, the image database may be included in the device 100, a web server, a cloud server, an SNS server, etc.

The image database may or may not previously define identification information of the target image. When the identification information of the target image is previously defined, the device 100 may search for the image by comparing the identification information of the target image with the search word. When the identification information of the target image is not previously defined, the device 100 may generate the identification information of the target image. The device 100 may compare the generated identification information of the target image with the search word.

When the search word is the positive search word, the device 100 may select the target images having the same positive search word from the image database. When the search word is the negative search word, the device 100 may select the target images that do not have the negative search word from the image database.

In operation S150, the device 100 may display the selected image. When a plurality of images is found, the device 100 may display the plurality of images on a single screen or may sequentially display the plurality of images. The device 100 may generate a folder corresponding to the selected images and store them in the folder. The device 100 may also receive a user input to display the images stored in the folder.

The device 100 may search for the image, but the disclosure is not just limited to that. For example, the device 100 and an external device may cooperate to search for an image. For example, the device 100 may display an image (operation S110), select a region of interest (operation S120), and determine the identification information of the region of interest as the search word (operation S130). The external device may then search for the image corresponding to the search word (operation S140), and the device 100 may display the image found by the external device (operation S150).

Alternatively, the external device may generate the identification information for the region of interest, and the device 100 may determine the search word in the identification information. The device 100 and the external device may split and perform functions of searching for the image using other methods. For convenience of description, a method in which only the device 100 searches for the image will be described below.

A method of displaying an indicator on a region of interest will be described below.

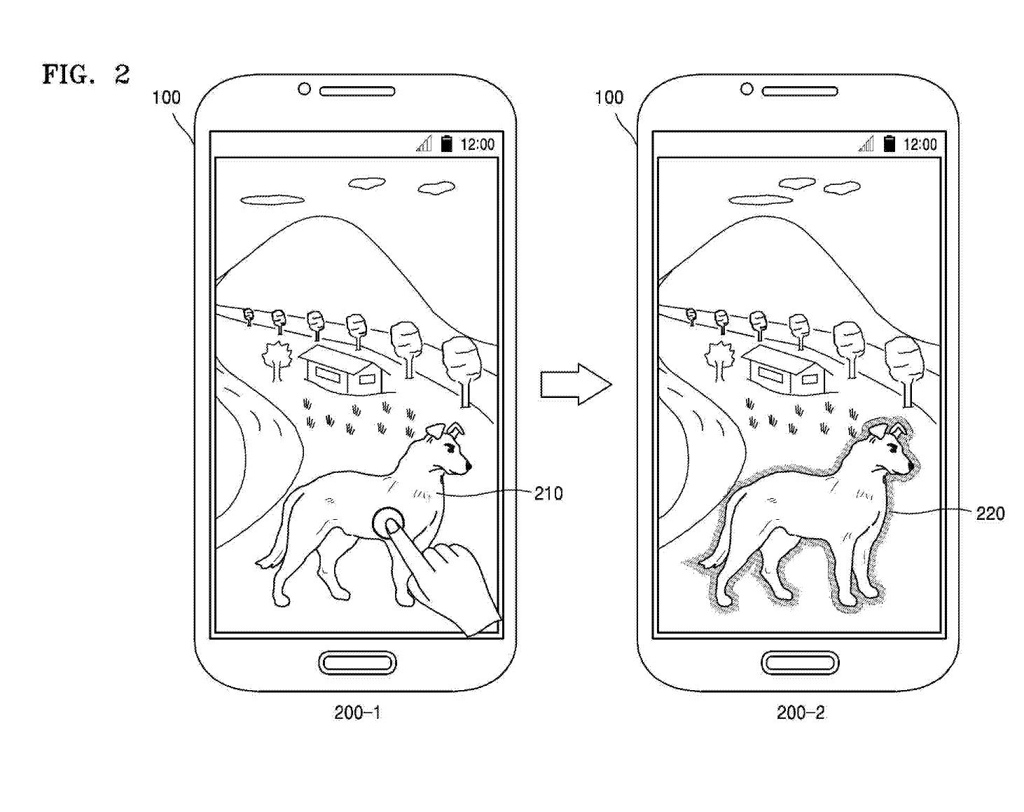

FIG. 2 is a reference view for explaining a method of providing an indicator 220 to an object 210, according to an exemplary embodiment. As shown in 200-1 of FIG. 2, the device 100 may display at least one image while a specific application, for example, a picture album application, is being executed. The device 100 may receive a user input to select the object 210 as a region of interest. A user may select a partial area where the object 210 is displayed via, for example, a tap action of touching the area where the object 210 is displayed with a finger or a touch tool and then quickly lifting the finger or the touch tool without moving the finger. The device 100 may distinguish the object displayed on the touched area from the rest of the image by using a graph cutting method, a level setting method, or the like. Accordingly, the device 100 may determine the object 310 as the region of interest.

As shown in 200-2 of FIG. 2, the device 100 may display the indicator 220 that indicates that the object 210 is a region of interest, where the indicator 220 highlights the border of the object 210. Various other types of indicators may be used to identify the region of interest.

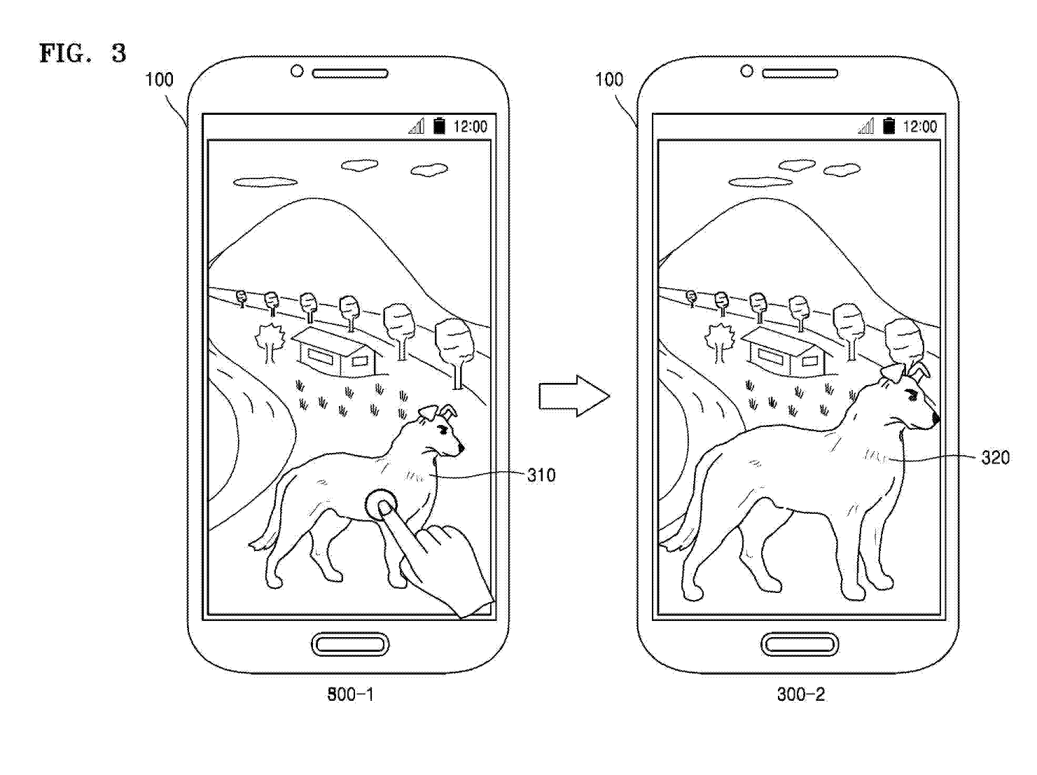

FIG. 3 is a reference view for explaining a method of providing an indicator to an object 310 by resizing the object 310, according to an exemplary embodiment.

Referring to 300-1 of FIG. 3, the device 100 may receive a user input to select the object 310 as a region of interest. For example, a user may touch an area of the object 310. The device 100 may select the object 310 as the region of interest in response to the user input and, as shown in FIG. 300-2 of FIG. 3, display a magnified object 320. Magnification of the object 310 may be the indicator that indicates the region of interest. The selected object 310 is magnified, while the remainder of the image remains the same.

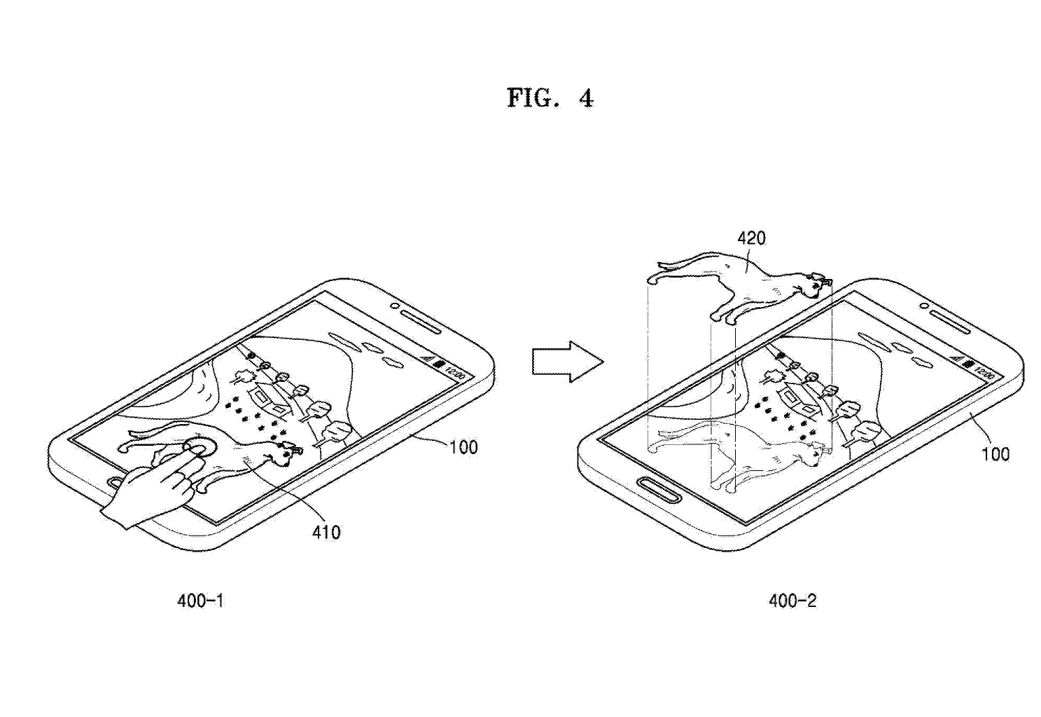

FIG. 4 is a reference view for explaining a method of providing an indicator 420 to an object 410 by changing depth information of a region of interest, according to an exemplary embodiment. Referring to 400-1 of FIG. 4, the device 100 may receive a user input selecting the object 410 as the region of interest. Then, the device 100 may determine the boundary of object 410 as the region of interest and, as shown in FIG. 400-2 of FIG. 4, provide the indicator 420 that changes the depth information of the object 410 such that the object 410 is displayed before being selected. There are various ways to indicate the region of interest, and only a few have been mentioned here as examples. Accordingly, various embodiments of the present disclosure may indicate the region of interest differently than by using the methods discussed so far.

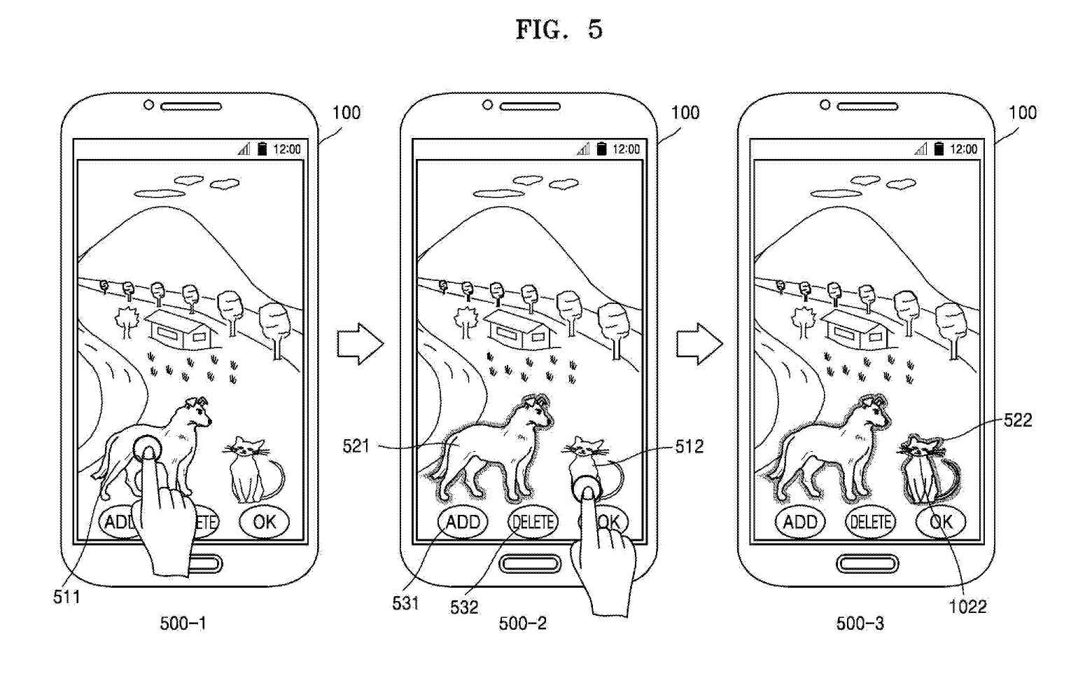

A plurality of objects may be selected as regions of interest. FIG. 5 is a reference view for explaining a method of selecting a plurality of objects 511 and 512 on a single image as a region of interest, according to an exemplary embodiment. Referring to 500-1 of FIG. 5, the device 100 may receive a user input of selecting the object 511 as the region of interest on an image. For example, a user may touch an area of the image on which the object 511 is displayed. Then, as shown in 500-2 of FIG. 5, the device 100 may display a first indicator 521 that indicates that the object 511 is the region of interest. The user may select the ADD icon 531 and then touch an area of the image on which the object 512 is displayed. The device 100 may then determine such an action of the user as a user input to add the object 512 as a region of interest, and, as shown in 500-3 of FIG. 5, the device 100 may display a second indicator 522 that indicates the object 512 is also a region of interest.

The region of interest may also be changed. In 500-2 of FIG. 5, the user may touch the DELETE icon 532 and then select the object 511 on which the first indicator 521 is displayed. Such an action of the user would prompt the device 100 to delete the object 511 as a region of interest and remove the first indicator 521. The device 100 may then determine that only the object 512 is the region of interest.

One user operation may be used to select a plurality of objects as a region of interest.

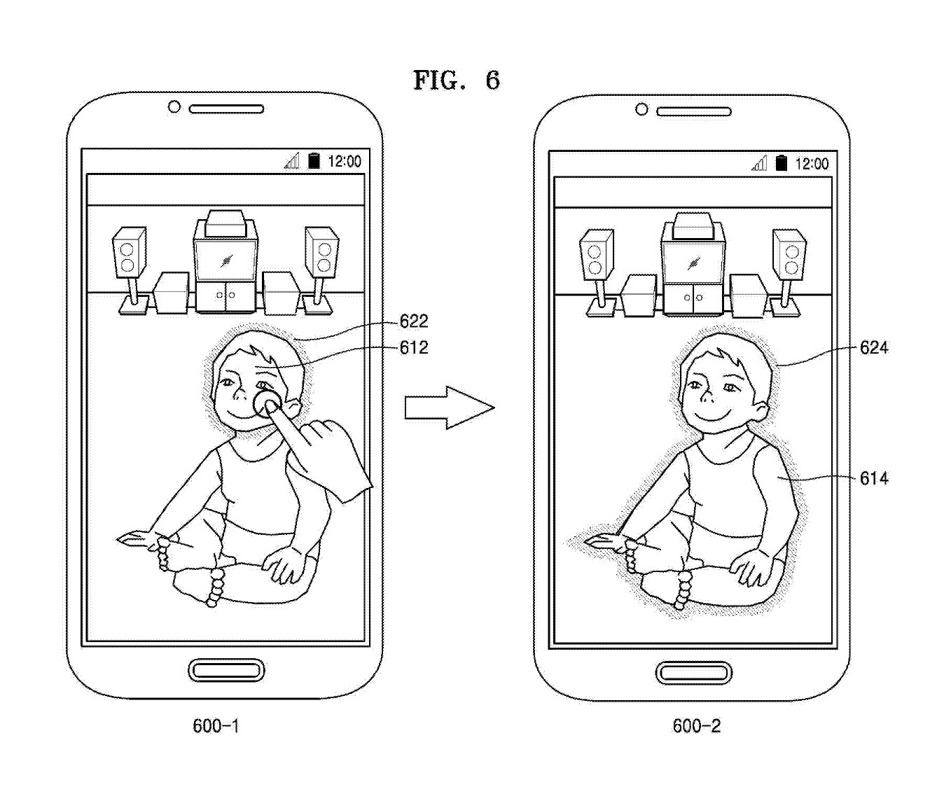

FIG. 6 is a reference view for explaining a method of selecting a plurality of objects on a single image as a region of interest, according to another exemplary embodiment. Referring to 600-1 of FIG. 6, a user may touch an area on which a face 612 is displayed. The device 100 may detect a boundary line using image analysis information and determine that the face 612 is the region of interest. The device 100 may display an indicator 622 indicating the region of interest as shown in 600-1 of FIG. 6.

The device 100 may increase the area of the region of interest in proportion to touch time. For example, if the user continues to touch the area on which the face 612 is displayed, as shown in 600-2 of FIG. 6, the device 100 may determine that the face 612 is associated with a person 614. Accordingly, the device 100 may designate the person 614 is the region of interest, and display an indicator 624 indicating that the entire person 614 is the region of interest.

A method of selecting the region of interest by touch is described above, but various embodiments of the disclosure are not limited to that. The region of interest may be selected by, for example, a drag action. The area of the face 612 may be touched and then dragged to an area on which a body of the person 614 is displayed. The device 100 may use this input to select the person 614 as the region of interest and display the indicator 624 indicating that the person 614 is the region of interest.

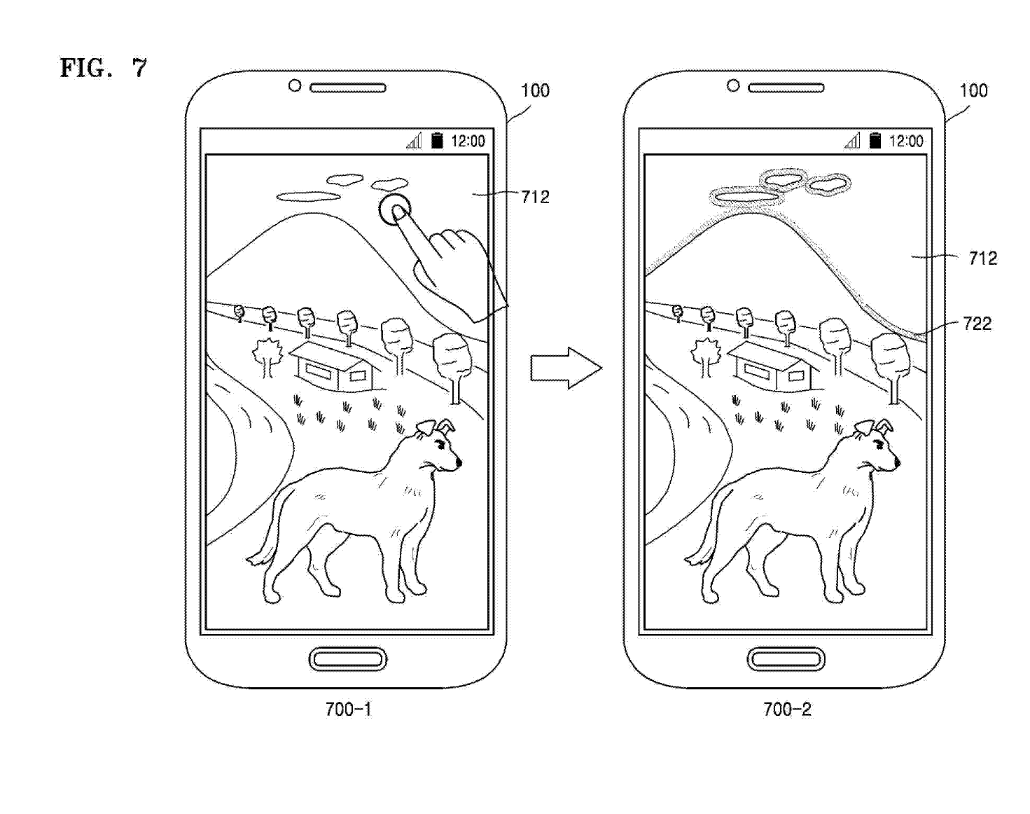

The region of interest may be applied to not only an object of an image but also a background of the image. FIG. 7 is a reference view for explaining a method of selecting a background as a region of interest, according to an exemplary embodiment. As shown in 700-1 of FIG. 7, a user may touch an area of the sky 712, and the device 100 may determine a boundary line in relation to the area touched by the user using image analysis information, etc. As shown in 700-2 of FIG. 7, an indicator 722 indicating that the sky 712 is the region of interest may be displayed. If a user touch time increases, the device 100 may determine that the mountain and the sky 712 are the region of interest.

When the background is selected as the region of interest, an expansion of the region of interest may be limited to the background. When an object is the region of interest, the expansion of the region of interest may be limited to the object. However, the exemplary embodiment is not limited thereto. The region of interest may be defined by a boundary line in relation to an area selected by the user, and thus the region of interest may be expanded to include the object or the background.

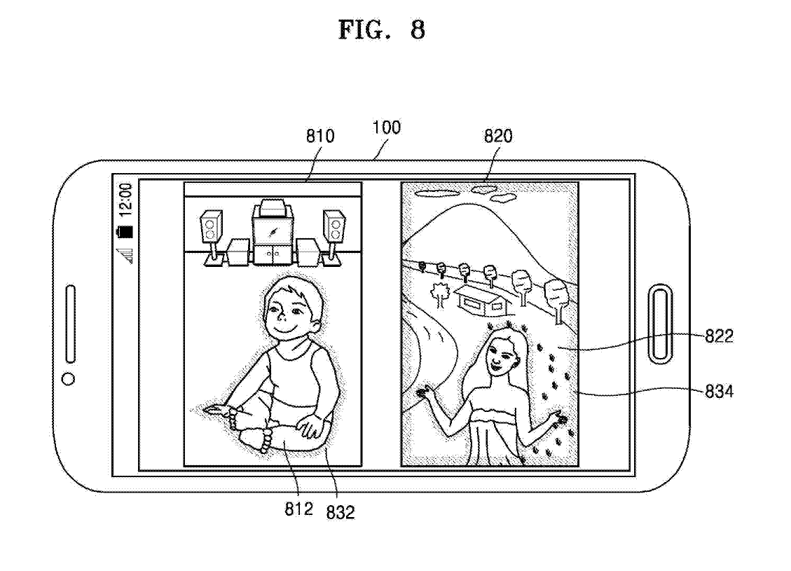

The region of interest may also be selected using a plurality of images. FIG. 8 is a reference view for explaining a method of selecting a region of interest using the first image 810 and the second image 820, according to an exemplary embodiment. Referring to FIG. 8, the device 100 may display the plurality of images. The device 100 may receive a user input of selecting a first partial image 812 of the first image 810 as the region of interest and a user input of selecting a second partial image 822 of the second image 820 as the region of interest. Then, the device 100 may display a first indicator 832 indicating that the first partial image 812 is the region of interest, and a second indicator 834 indicating that the second partial image 822 is the region of interest.

Although the first partial image 812 is illustrated as an object of the first image 810, and the second partial image 822 is illustrated as a background of the second image 820, this is merely for convenience of description and the first partial image 812 and the second partial image 822 are not limited thereto. Either of the selected first and second partial images 812 and 822 may be objects or backgrounds. The first and second images 810 and 820 may be the same image. As described above, since the region of interest may be expanded between objects or backgrounds, when both an object and a background of one image are selected as the region of interest, the device 100 may display two first images and select the object in one image and the background in another image according to a user input.

When the region of interest is selected, the device 100 may obtain identification information of the region of interest.

In the present specification, the “Identification information” denotes a key word, a key phrase, or the like that identifies an image, and the identification information may be defined for each object and each background. For example, the object and the background may each have at least one piece of identification information. According to an exemplary embodiment of the present disclosure, the identification information may be acquired using attribute information of an image or image analysis information of the image.

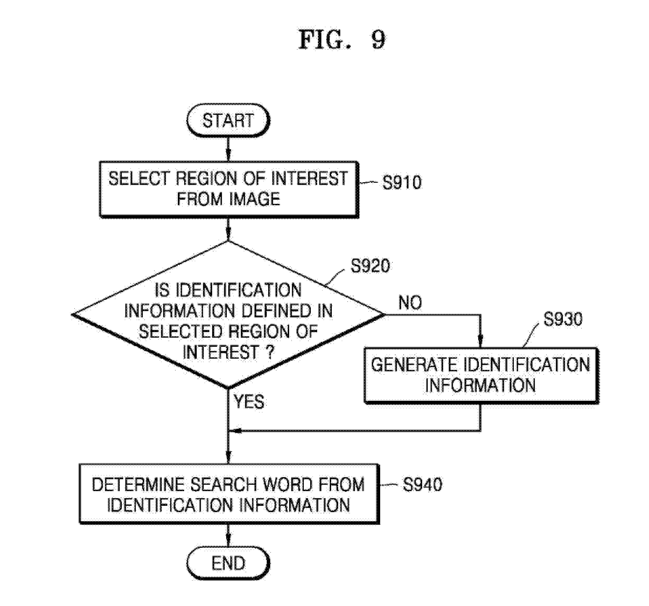

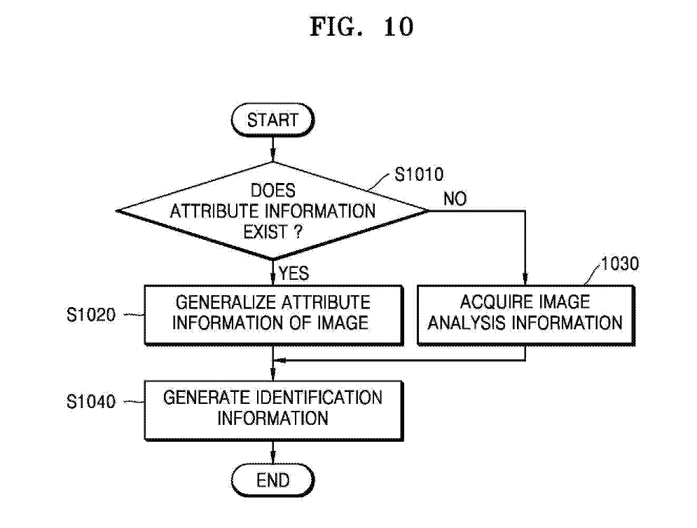

FIG. 9 is a flowchart of a method in which the device 100 determines a search word from identification information, according to an exemplary embodiment.

In operation S910, the device 100 may select a region of interest from an image. For example, as described above, the device 100 may display the image and select as the region of interest an object or a background within the image in response to a user input. The device 100 may provide an indicator indicating the region of interest. The image may be a still image, a moving image frame which is a part of a moving image (i.e., a still image of a moving image), or a live view image. When the image is a still image or a moving image frame, the still image or the moving image may be an image pre-stored in the device 100, or may be an image stored in and transmitted from an external device. When the image is a live view image, the live view image may be an image captured by a camera embedded in the device 100, or an image captured and transmitted by a camera that is an external device.

In operation S920, the device 100 may determine whether identification information is defined in the selected region of interest. For example, when the image is stored, pieces of identification information respectively describing an object and a background included in the image may be matched with the image and stored. In this case, the device 100 may determine that identification information is defined in the selected region of interest. According to an exemplary embodiment of the present disclosure, pieces of identification information respectively corresponding to the object and the background may be stored in the form of metadata for each image.

In operation S930, if no identification information is defined in the selected region of interest, the device 100 may generate identification information. For example, the device 100 may generate identification information by using attribute information stored in the form of metadata or by using image analysis information that is acquired by performing image processing on the image. Operation S930 will be described in greater detail later with reference to FIG. 10.

In operation S940, the device 100 may determine at least one piece of the identification information as a search word according to a user input. The search word may include a positive search word that needs to be included as identification information of a target image and a negative search word that does not need to be included as the identification information of the target image. Whether the search word is the positive search word or the negative search word may be determined according to the user input.

FIG. 10 is a flowchart of a method in which the device 100 generates identification information, according to an exemplary embodiment. FIG. 10 illustrates a case where identification information of a region of interest within an image is not predefined. The identification information generating method of FIG. 10 may be also applicable to when identification information of a target image is generated.

In operation S1010, the device 100 may determine whether attribute information corresponding to the region of interest exists. For example, the device 100 may check metadata corresponding to the region of interest. The device 100 may extract the attribute information of the region of interest from the metadata.

According to an exemplary embodiment, the attribute information represents the attributes of an image, and may include at least one of information about the format of the image, information about the size of the image, information about an object included in the image (for example, a type, a name, a status of the object, etc.), source information of the image, annotation information added by a user, context information associated with image generation (weather, temperature, etc.), etc.

In operations S1020 and S1040, the device 100 may generalize the attribute information of the image and generate the identification information. In one embodiment, generalizing attribute information may mean expressing the attribute information in an upper-level language based on the WordNet (hierarchical terminology referencing system). Other embodiments may use other ways or databases to express and store information.

‘WordNet’ is a database that provides definitions or usage patterns of words and establishes relations among words. The basic structure of WordNet includes logical groups called synsets having a list of semantically equivalent words, and semantic relations among these synsets. The semantic relations include hypernyms, hyponyms, meronyms, and holonyms. Nouns included in WordNet have an entity as an uppermost word and form hyponyms by extending the entity according to senses. Thus, WordNet may also be called an ontology having a hierarchical structure by classifying and defining conceptual vocabularies.

‘Ontology’ denotes a formal and explicit specification of a shared conceptualization. An ontology may be considered a sort of dictionary comprised of words and relations. In the ontology, words associated with a specific domain are expressed hierarchically, and inference rules for extending the words are included.

For example, when the region of interest is a background, the device 100 may classify location information included in the attribute information into upper-level information and generate the identification information. For example, the device 100 may express a global positioning system (GPS) coordinate value (latitude: 37.4872222, longitude: 127.0530792) as a superordinate concept, such as a zone, a building, an address, a region name, a city name, or a country name. In this case, the building, the region name, the city name, the country name, and the like may be generated as identification information of the background.

In operations S1030 and S1040, if the attribute information corresponding to the region of interest does not exist, the device 100 may acquire image analysis information of the region of interest and generate the identification information of the region of interest by using the image analysis information.

According to an exemplary embodiment of the present disclosure, the image analysis information is information corresponding to a result of analyzing data that is acquired via image processing. For example, the image analysis information may include information about an object displayed on an image (for example, the type, status, and name of the object), information about a location shown on the image, information about a season or time shown on the image, and information about an atmosphere or emotion shown on the image, but embodiments are not limited thereto.

For example, when the region of interest is an object, the device 100 may detect a boundary line of the object in the image. According to an exemplary embodiment of the present disclosure, the device 100 may compare the boundary line of the object included in the image with a predefined template and acquire the type, name, and any other information available for the object. For example, when the boundary line of the object is similar to a template of a vehicle, the device 100 may recognize the object included in the image as a vehicle. In this case, the device 100 may display identification information ‘car’ by using information about the object included in the image.

Alternatively, the device 100 may perform face recognition on the object included in the image. For example, the device 100 may detect a face region of a human from the image. Examples of a face region detecting method may include knowledge-based methods, feature-based methods, template-matching methods, and appearance-based methods, but embodiments are not limited thereto.

The device 100 may extract face features (for example, the shapes of the eyes, the nose, and the mouth as major parts of a face) from the detected face region. To extract a face feature from a face region, a Gabor filter, a local binary pattern (LBP), or the like may be used, but embodiments are not limited thereto.

The device 100 may compare the face feature extracted from the face region within the image with face features of pre-registered users. For example, when the extracted face feature is similar to a face feature of a pre-registered first register, the device 100 may determine that the first user is included as a partial image in the selected image. In this case, the device 100 may generate identification information ‘first user’, based on a result of face recognition.

Alternatively, when a selected object is a person, the device 100 may recognize a posture of the person. For example, the device 100 may determine body parts of the object based on a body part model, combine the determined body parts, and determine the posture of the object.

The body part model may be, for example, at least one of an edge model and a region model. The edge model may be a model including contour information of an average person. The region model may be a model including volume or region information of the average person.

As an exemplary embodiment, the body parts may be divided into ten parts. That is, the body parts may be divided into a face, a torso, a left upper arm, a left lower arm, a right upper arm, a right lower arm, a left upper leg, a left lower leg, a right upper leg, and a right lower leg.

The device 100 may determine the posture of the object using the determined body parts and basic body part location information. For example, the device 100 may determine the posture of the object using the basic body part location information such as information that the face is located on an upper side of the torso or information that the face and a leg are located on opposite ends of a human body.

According to an exemplary embodiment of the present disclosure, the device 100 may compare a certain area of an image with a color map (color histogram) and extract visual features, such as a color arrangement, a pattern, and an atmosphere of the image, as the image analysis information. The device 100 may generate identification information by using the visual features of the image. For example, when the image includes a sky background, the device 100 may generate identification information ‘sky’ by using visual features of the sky background.

According to an exemplary embodiment of the present disclosure, the device 100 may divide the image in units of areas, search for a cluster that is the most similar to each area, and generate identification information connected with a found cluster.

If the attribute information corresponding to the image does not exist, the device 100 may acquire image analysis information of the image and generate the identification information of the image by using the image analysis information.

Meanwhile, FIG. 10 illustrates an exemplary embodiment in which the device 100 acquires image analysis information of an image when attribute information of the image does not exist but is not limited thereto.

For example, the device 100 may generate identification information by using only either image analysis information or attribute information. Alternatively, even when the attribute information exists, the device 100 may further acquire the image analysis information. In this case, the device 100 may generate identification information by using both the attribute information and the image analysis information.

According to an exemplary embodiment of the present disclosure, the device 100 may compare pieces of identification information generated based on attribute information with pieces of identification information generated based on image analysis information and determine common identification information as final identification information. Common identification information may have higher reliability than non-common identification information. The reliability denotes the degree to which pieces of identification information extracted from an image are trusted to be suitable identification information.

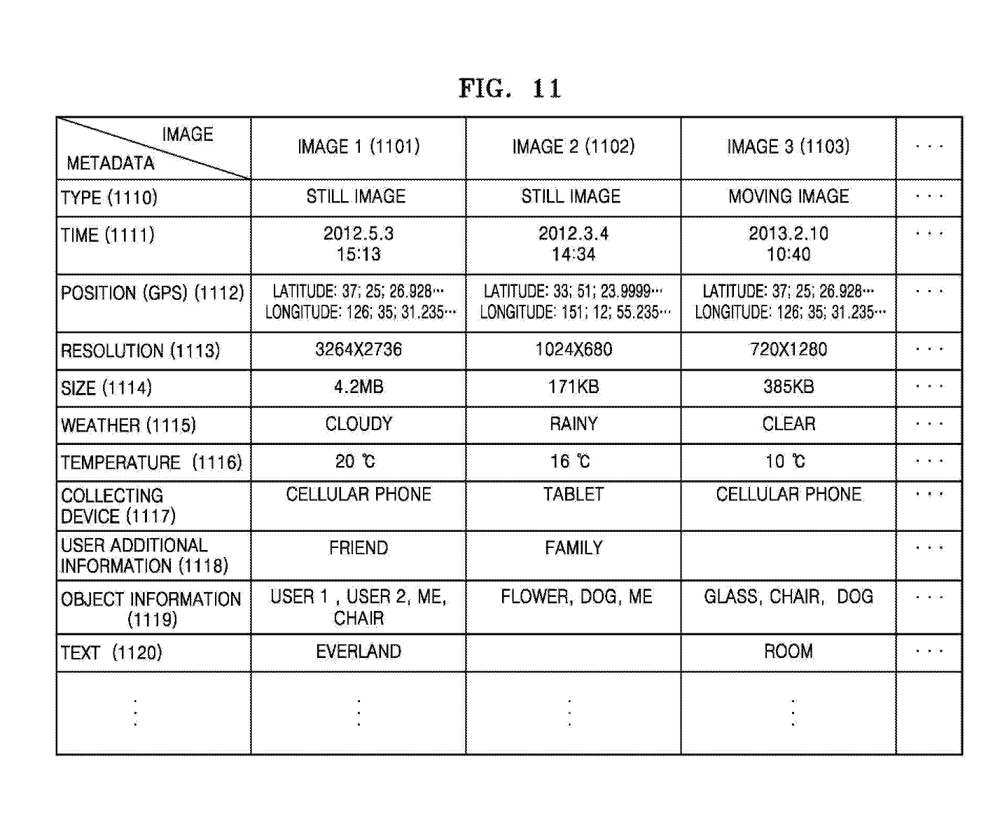

FIG. 11 illustrates attribute information of an image according to an exemplary embodiment. As shown in FIG. 11, the attribute information of the image may be stored in the form of metadata. For example, data such as type 1110, time 1111, GPS 1112, resolution 1113, size 1114, and collecting device 1117 may be stored as attribute information for each image.

According to an exemplary embodiment of the present disclosure, context information used during image generation may also be stored in the form of metadata. For example, when the device 100 generates a first image 1101, the device 100 may collect weather information (for example, cloudy), temperature information (for example, 20° C.), and the like from a weather application when the first image 1101 is generated. The device 100 may store weather information 1115 and temperature information 1116 as attribute information of the first image 1101. The device 100 may collect event information (not shown) from a schedule application when the first image 1101 is generated. In this case, the device 100 may store the event information as attribute information of the first image 1101.

According to an exemplary embodiment of the present disclosure, user additional information 1118, which is input by a user, may also be stored in the form of metadata. For example, the user additional information 1118 may include annotation information input by a user to explain an image, and information about an object that is explained by the user.

According to an exemplary embodiment of the present disclosure, image analysis information (for example, object information 1119, etc.) acquired as a result of image processing with respect to an image may be stored in the form of metadata. For example, the device 100 may store information about objects included in the first image 1101 (for example, user 1, user 2, me, and a chair) as the attribute information about the first image 1101.

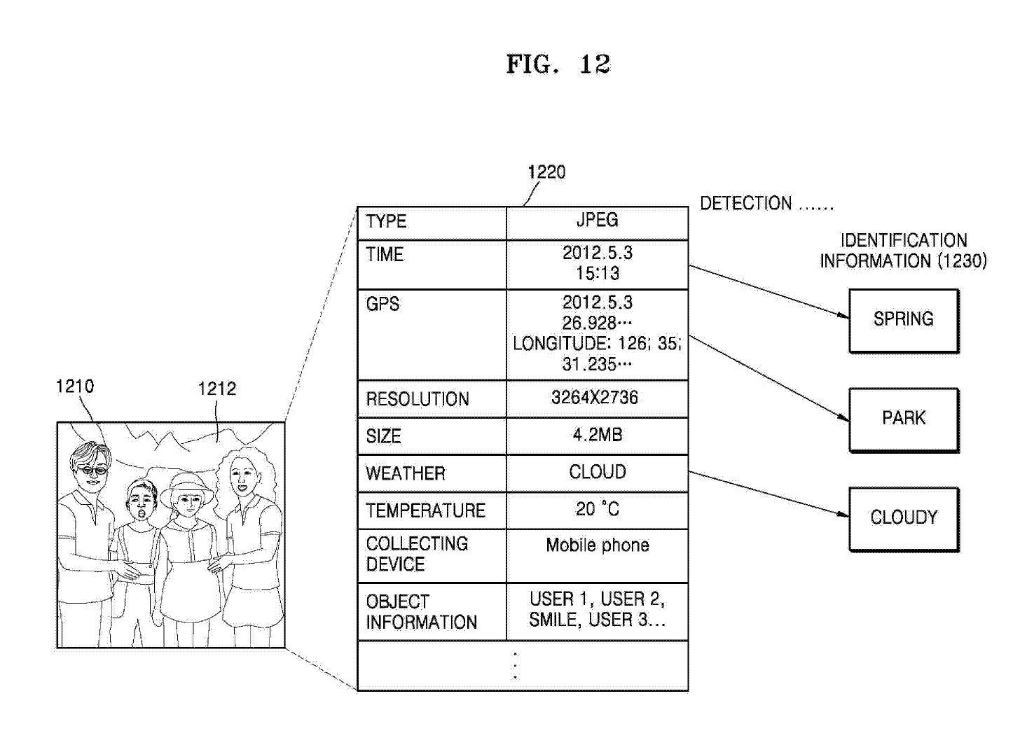

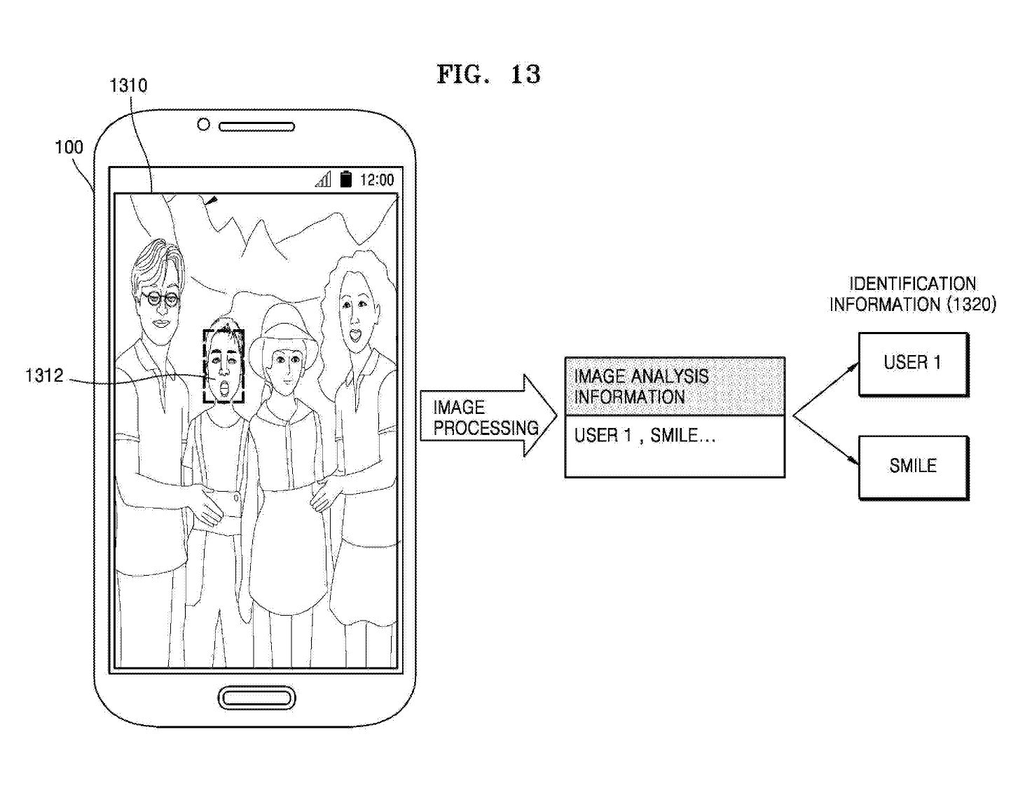

FIG. 12 is a reference view for explaining an example in which the device 100 generates identification information of an image based on attribute information of the image.

According to an exemplary embodiment of the present disclosure, the device 100 may select a background 1212 of an image 1210 as a region of interest, based on user input. In this case, the device 100 may check attribute information of the selected background 1212 within attribute information 1220 of the image 1210. The device 100 may detect identification information 1230 by using the attribute information of the selected background 1212.

For example, when a region selected as a region of interest is a background, the device 100 may detect information associated with the background from the attribute information 1220. The device 100 may generate identification information regarding a season which is ‘spring’ by using time information (for example, 2012.5.3.15:13), identification information ‘park’ by using location information (for example, latitude: 37; 25; 26.928 . . . , longitude: 126; 35; 31.235 . . . ) within the attribute information 1220, and identification information ‘cloudy’ by using weather information (for example, cloud) within the attribute information 1220.

FIG. 13 is a reference view for explaining an example in which the device 100 generates identification information by using image analysis information. According to an exemplary embodiment of the present disclosure, the device 100 may select a first object 1312 of an image 1310 as a region of interest, based on a user input. In this case, the device 100 may generate identification information (for example, a human and a smiling face) describing the first object 1312, by performing an image analysis with respect to the first object 1312.

For example, the device 100 may detect a face region of a human from the region of interest. The device 100 may extract a face feature from the detected face region. The device 100 may compare the extracted face feature with face features of pre-registered users and generate identification information representing that the selected first object 1312 is user 1. The device 100 may also generate identification information ‘smile’, based on a lip shape included in the detected face region. Then, the device 100 may acquire ‘user 1’ and ‘smile’ from identification information 1320.

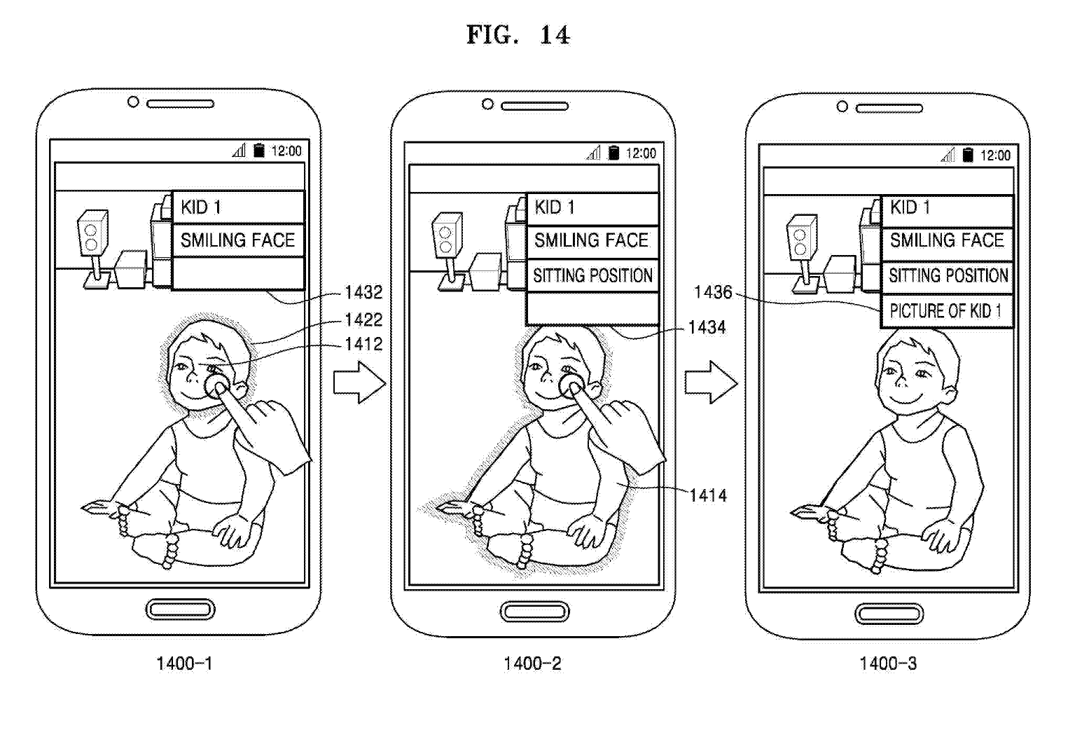

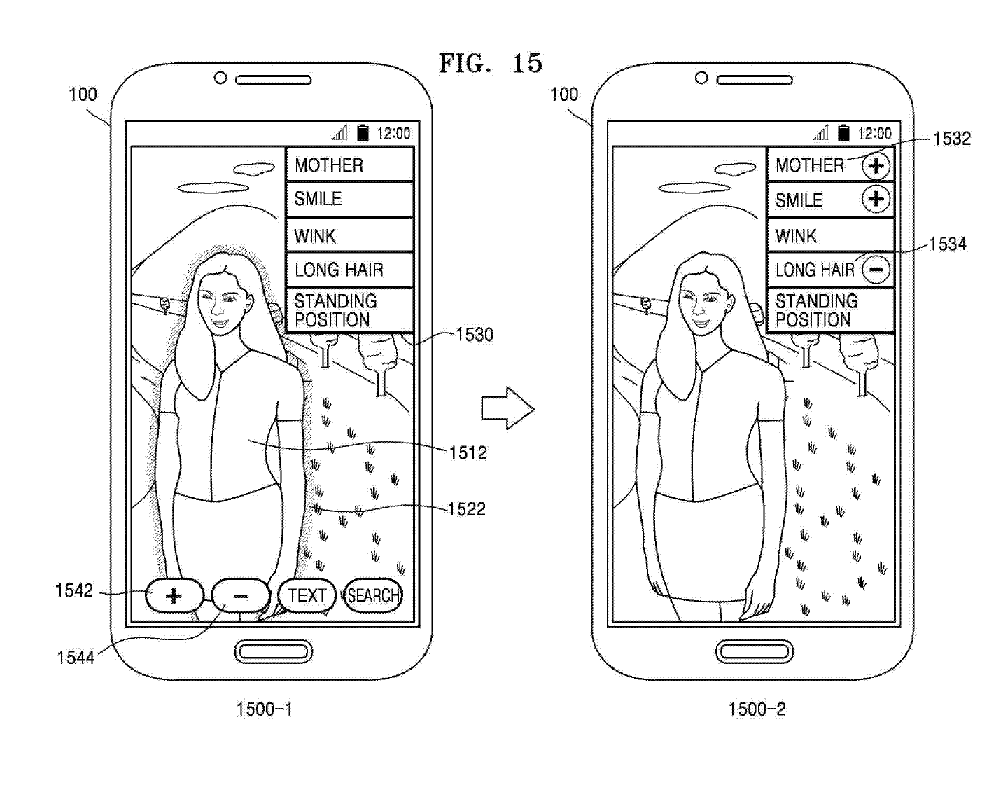

The device 100 may display identification information of a region of interest. Displaying the identification information may be omitted. When there is a plurality of pieces of identification information of the region of interest, the device 100 may select at least a part of the identification information as a search word. FIG. 14 illustrates an example in which the device 100 displays an identification information list 1432, according to an exemplary embodiment. A user may touch an area on which a face 1412 is displayed. The device 100 may detect a boundary line using image analysis information, determine that the face 1412 is the region of interest, and display an indicator 1422 indicating the region of interest. Furthermore, the device 100 may acquire identification information of the face 1412 using face recognition algorithm, the image analysis information, etc. and, as shown in 1400-1 of FIG. 14, display the identification information list 1432.

If the user continues to touch the face 1412, the device 100 may determine that the whole person 1414 is the region of interest. After acquiring identification information of the whole person 1414, the device 100 may display the identification information list 1432 as shown in 1400-2 of FIG. 14. Furthermore, if a user continues to touch, the device 100 may try to determine whether any other objects exist in the image other than the person 1414. If no other object exists, as shown in 1400-3 of FIG. 14, the device 100 acquires identification information indicating that the image is “a picture of kid 1” and displays the identification information list 1432.

The device 100 may determine at least one piece of the acquired identification information as a search word. FIG. 15 is a reference view for explaining a method of determining a search word from identification information according to an exemplary embodiment. Referring to 1500-1 of FIG. 15, the device 100 may select a first object 1512 in an image as a region of interest based on user input. The device 100 may display an indicator 1522 indicating that the first object 1512 is the region of interest, acquire identification information of the first object 1512, and display an identification information list 1530. For example, the device 100 may acquire identification information such as the words smile, mother, and wink.

The device 100 may receive user input to select at least one information from the identification information list 1530. If a user selects a positive (+) icon 1542 and the word “mother” from the identification information, the device 100 may determine the word “mother” as a positive search word, and, as shown in 1500-2 of FIG. 15, may display a determination result 1532. If a user selects a negative (−) icon 1544 and the words “long hair” from the identification information, the device 100 may use the words “long hair” as a negative search word, and, as shown in 1500-2 of FIG. 15, the device 100 may display a determination result 1534.

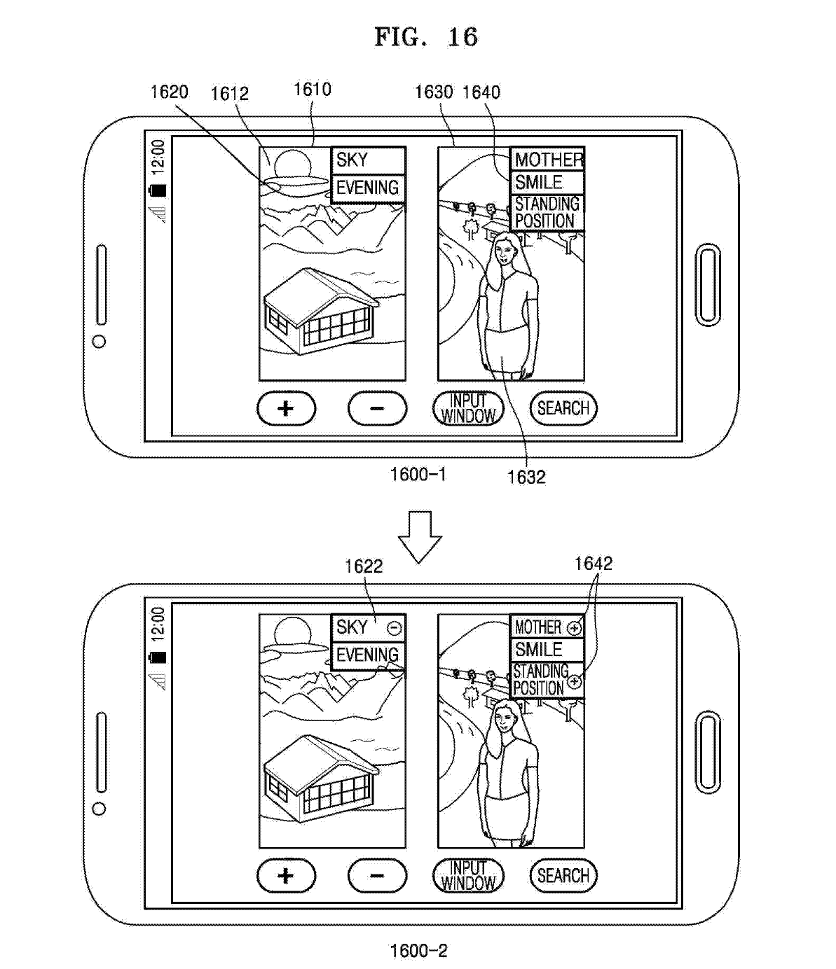

As described above, a search word may be determined from a plurality of images. FIG. 16 is a reference view for explaining a method of determining a search word from a plurality of images according to an exemplary embodiment.

Referring to 1600-1 of FIG. 16, the device 100 may select a first object 1612 in a first image 1610 as a region of interest based on a user input, acquire identification information for the region of interest, and display an acquisition result 1620. Likewise, the device 100 may select a second object 1630 in a second image 1630 as the region of interest based on a user input, acquire identification information of the region of interest, and display an acquisition result 1640.

The device 100 may determine “sky” in the identification information of the first object 1612 as a negative search word, and as shown in 1600-2 of FIG. 16, display a determination result 1622. For example, if the user touches a negative icon and then “sky,” the device 100 may determine “sky” as the negative search word. Furthermore, the device 100 may determine “mother” and “standing position” in the identification information of the second object 1632 as positive search words and display a determination result 1642.

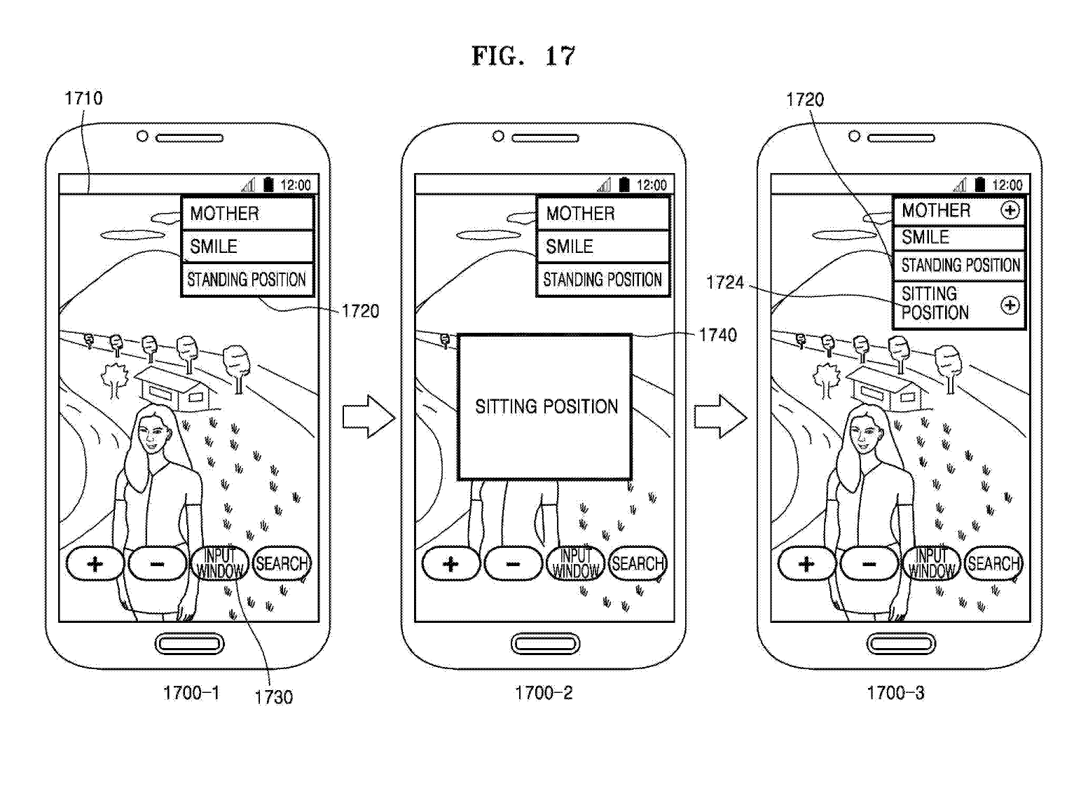

The device 100 may add text directly input by a user as a search word, in addition to identification information of an image when searching for the image. FIG. 17 is a reference view for explaining a method in which the device 100 includes text as a search word according to an exemplary embodiment.

Referring to 1700-1 of FIG. 17, the device 100 may select a first object 1712 in an image 1710 as a region of interest based on a user input and display an identification information list 1720 with respect to the region of interest. Meanwhile, when the identification information list 1720 does not include identification information of a search word that is to be searched for, a user may select an input window icon 1730. Then, as shown in 1700-2 of FIG. 17, an input window 1740 may be displayed as a pop-up window. The user may describe identification information in the input window 1740. In 1700-2 of FIG. 17, the user inputs text 1724 of “sitting position.” As shown in 1700-3 of FIG. 17, the device 100 may display the text 1724 included in the identification information list 1720. The identification information is described as text in FIG. 17 but is not limited thereto. The user may draw a painting, and the device 100 may acquire identification information from the painting displayed on the input window 1740.

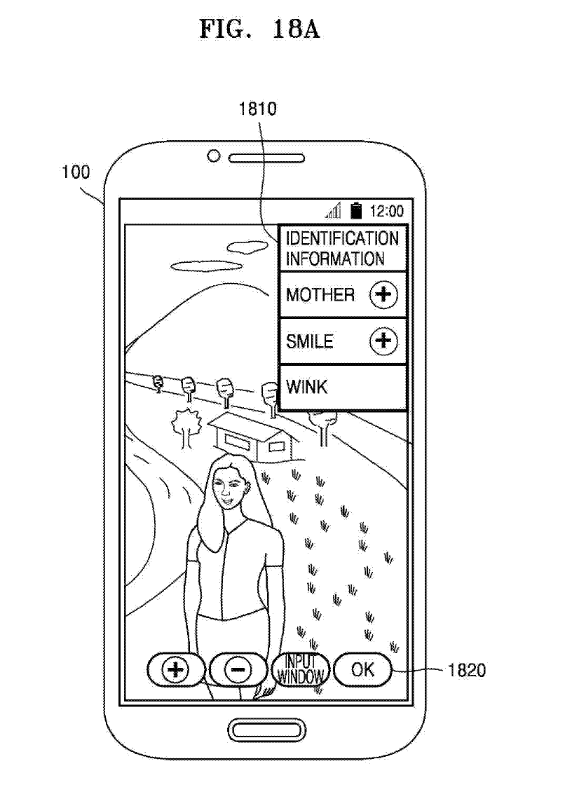

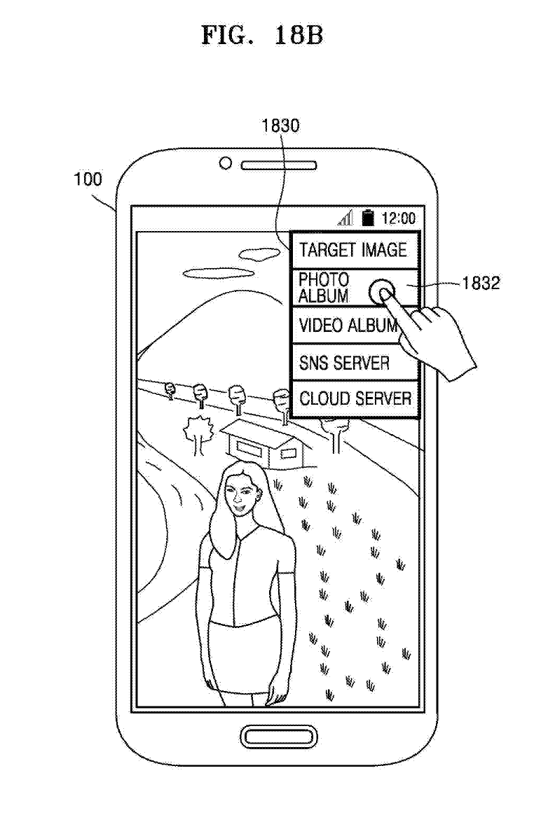

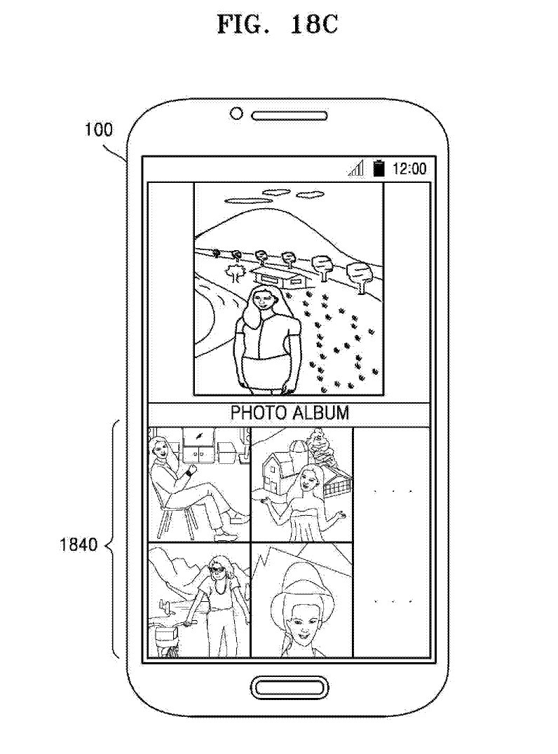

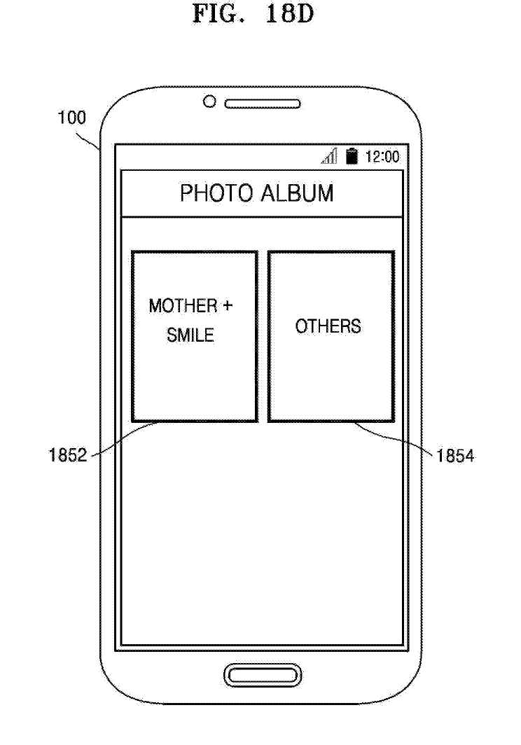

When the search word is determined, the device 100 may search for an image corresponding to the search word from an image database. FIGS. 18A through 18D are reference views for explaining a method of providing a search result according to an exemplary embodiment.

As shown in FIG. 18A, the device 100 may display an identification information list 1810 with respect to a region of interest in an image and determine at least one piece of identification information by a user input. A user may select a confirmation button (OK) 1820.

Then, as shown in FIG. 18B, the device 100 may display an image database list 1830. The device 100 may determine the image database through a user input of selecting at least a part of the image database list 1830.

The device 100 may compare identification information of a target image of the determined image database and a search word and search for an image corresponding to the search word. When the target image is a still image, the device 100 may search for the image in a still image unit. When the target image is a moving image, the device 100 may search for the image in a moving image frame unit. When the search word is a positive search word, the device 100 may search for an image having the positive search word as identification information from an image database. When the search word is a negative search word, the device 100 may search for an image that does not have the negative search word as identification information from the image database.

Identification information may be or may not be predefined in the target image included in the image database. If the identification information is predefined in the target image, the device 100 may search for the image based on whether the identification information of the target image matches appropriately, either positively or negatively, with the search word. If no identification information is predefined in the target image, the device 100 may generate the identification information of the target image. The device 100 may search for the image based on whether the search word matches appropriately the identification information of the target image. However, even if the identification information is predefined, as explained above, various embodiments of the disclosure may be able to add additional words the identification information.

As shown in FIG. 18C, the device 100 may display a found image 1840. When there are is plurality of found images 1840, the device 100 may arrange the plurality of found images 1840 based on at least one of image generation time information, image generation location information, capacity information of an image, resolution information of the image, and a search order. Alternatively, the device 100 may sequentially display the plurality of found images 1840 over time. Alternatively, when the target image is a moving image, the image corresponding to the search word may be a moving image frame. Thus, the device 100 may display only the image corresponding to the search word using a moving image reproduction method.

Alternatively, as shown in FIG. 18D, the device 100 may generate and display a first folder 1852 including the image corresponding to the search word and a second folder 1854 including other images. Images and link information of the images may be stored in the first and second folders 1852 and 1854.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of searching for an image, the method comprising:
receiving a first user input to select a region of interest in a displayed image;
displaying an indicator showing the region of interest;
determining a search word, wherein the search word comprises at least one piece of an identification information for the region of interest;
searching at least one target image in an image database by using the search word, wherein when the search word matches appropriately an identification information of any of the at least one target image, that target image that matches is a found image; and
displaying the found image.

2. The method of claim 1, wherein the indicator is displayed using at least one of highlighting a boundary line of the region of interest, changing a size of the region of interest, and changing depth information of the region of interest.

3. The method of claim 1, wherein the first user input is a user touch on an area of the displayed image.

4. The method of claim 3, wherein a size of the region of interest is changed according to a duration of the user touch.

5. The method of claim 4, wherein the size of the region of interest increases according to an increase of the duration of the user touch.

6. The method of claim 1, wherein the region of interest is at least one of an object, a background, and text included in the image.

7. The method of claim 1, the method further comprising displaying the identification information for the region of interest.

8. The method of claim 7, wherein the search word is determined by a second user input to select at least one piece of the displayed identification information.

9. The method of claim 1, wherein when the search word is a positive search word, the found image is any of the at least one target image having the search word as a piece of the identification information.

10. The method of claim 1, wherein when the search word is a negative search word, the found image is any of the at least one target image that does not have the search word as a piece of the identification information.

11. The method of claim 1, wherein the found image is acquired based on at least one of attribute information of the region of interest and image analysis information of the image.

12. The method of claim 1, wherein the displayed image comprises a first image and a second image, and wherein the region of interest comprises a first partial image of the first image and a second partial image of the second image.

13. The method of claim 1, further comprising:
receiving text; and
determining the text as the search word.

14. The method of claim 1, wherein the image database is stored in at least one of a web server, a cloud server, a social networking service (SNS) server, and a portable device.

15. The method of claim 1, wherein the displayed image is at least one of a live view image, a still image, and a moving image frame.

16. The method of claim 1, wherein the found image is a moving image frame, and when there is a plurality of the found image, displaying the found image comprises sequentially displaying the moving image frame.

17. A device comprising:
a display unit configured to display a displayed image;
a user input unit configured to receive a user input to select a region of interest; and
a control unit configured to control the display unit to display an indicator about the region of interest.

18. The device of claim 17, further comprising:
a database configured to store target images,
wherein the control unit is further configured to determine at least one piece of identification information for the region of interest based on a result received from the user input unit and to search for a target image with an identification information corresponding to a search word.

19. The device of claim 18, wherein the identification information is a posture of a person included in the region of interest.

20. The device of claim 18, wherein when the search word is a positive search word, a found image is the target image with the identification information corresponding to the search word, and when the search word is a negative search word, the found image is the target image with the identification information that does not correspond to the search word.
